(19) United States
(12) Patent Application Publication
(10) Pub. No.: US 2026/0186105 A1
(43) Pub. Date: Jul. 2, 2026

(54) OPTICAL SCANNING SYSTEM, LASER RADAR AND VEHICLE

(71) Applicant: HON HAI PRECISION INDUSTRY CO., LTD., New Taipei (TW)

(72) Inventor: YUNG-CHANG TSENG, New Taipei (TW)

(21) Appl. No.: 19/405,610

(22) Filed: Dec. 2, 2025

(30) Foreign Application Priority Data
Dec. 26, 2024 (CN) 202411941514.7

(51) Int. Cl. G01S 7/481; G01S 17/931

(52) U.S. Cl. CPC G01S 7/4817; G01S 17/931

(57) ABSTRACT

Embodiments of the present disclosure relate to an optical scanning system, a laser radar and a vehicle. The optical scanning system includes a polarization converter, a polarization beam splitter, a phase delay element, and a scanning element. The polarization converter is configured to receive a first light having a first polarization state and a second light having a second polarization state and emit a third light having the second polarization state. The polarization beam splitter is configured to reflect the third light. The phase delay element is configured to receive the third light and emit a fourth light. The scanning element is configured to receive the fourth light and emit a fifth light. The phase delay element is further configured to convert the fifth light into a scanning light having the first polarization state, and the polarization beam splitter is further configured to transmit the scanning light.

### FIELD

The subject matter herein generally relates to autonomous driving, specifically an optical scanning system, a laser radar and a vehicle.

### BACKGROUND

Lidar has broad application prospects in the fields of remote sensing and unmanned driving. Laser radar includes a transmitting system, a scanning system, a receiving system and a processing system. The scanning system includes a scanning element, and the laser is emitted from the transmitting system into the free space. The direction of the laser emission into the free space is adjusted by the scanning element of the scanning system. In the prior art, an ordinary spectroscope is usually used in the scanning system to achieve that the incident light entering the scanning element and the scanning light emitted from the scanning element are on the same optical axis. The reflectivity and transmittance of an ordinary spectroscope for non-polarized light are both 50%, so each time the light passes through an ordinary spectroscope, 50% of the light energy will be lost. The light emitted from the transmitting system needs to pass through the ordinary spectroscope twice, and each time the light passes through the ordinary spectroscope, 50% of the light energy will be lost. This is equivalent to a total loss of 75% of the light energy when the light passes through the ordinary spectroscope twice, thereby reducing the light efficiency of the outgoing light. Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic structural diagram of an optical scanning system according to an embodiment of the present disclosure.

FIG. 2 is a schematic structural diagram of a polarization converter in FIG. 1.

FIG. 3 is a schematic structural diagram of a polarization converter according to another embodiment of the present disclosure.

FIG. 4 is a schematic structural diagram of a laser radar according to an embodiment of the present disclosure.

FIG. 5 is a schematic module diagram of the laser radar in FIG. 4.

FIG. 6 is a schematic module diagram of a vehicle according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

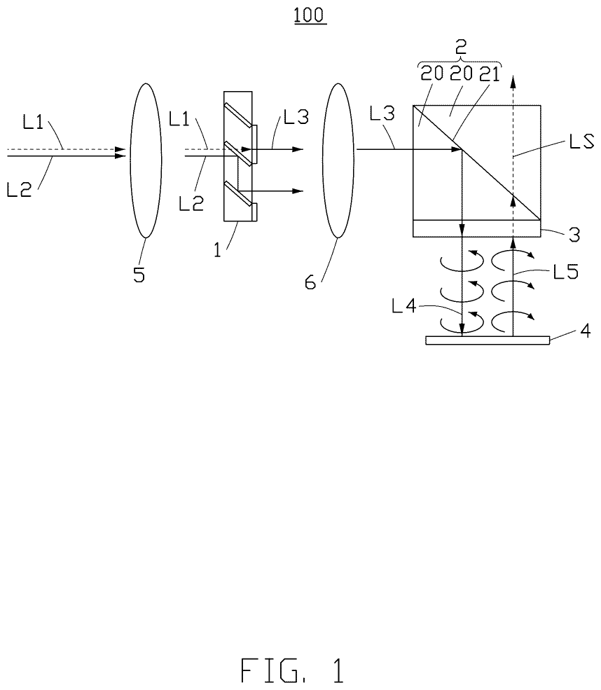

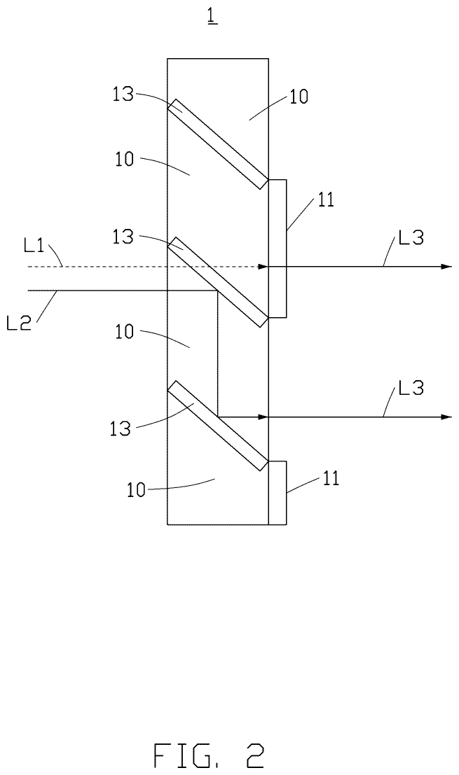

As shown in FIG. 1 and FIG. 2, an optical scanning system 100 includes a polarization converter 1, a polarization beam splitter 2, a phase delay element 3 and a scanning element 4.

The polarization converter 1 is configured to receive a first light L1 having a first polarization state and a second light L2 having a second polarization state. The first polarization state is different from the second polarization state. The polarization converter 1 is configured to convert the polarization state of the first light L1 into the second polarization state and emit a third light L3 having the second polarization state.

The polarization beam splitter 2 is configured to receive and reflect the third light L3. The phase delay element 3 is on a reflected light side of the polarization beam splitter 2 and is configured to receive the third light L3 and emit a fourth light L4 having a third polarization state. The third polarization state is different from each of the first polarization state and the second polarization state.

The scanning element 4 is configured to receive the fourth light L4 and emit a fifth light L5 having a fourth polarization state toward the phase delay element 3. The fourth polarization state is different from each of the first polarization state, the second polarization state, and the third polarization state. The scanning element 4 is further configured to emit the fifth light L5 in a variable direction within a scanning angle. The fifth light L5 emitted from the scanning element 4 is converted into a scanning light LS having the first polarization state by the phase delay element 3, and the polarization beam splitter 2 on a light output side of the phase delay element 3 is configured to transmit and emit the scanning light LS.

The optical scanning system 100 obtains light of a specific polarization state by the polarization converter 1, and the light of a specific polarization state can be transmitted or reflected from the polarization beam splitter 2, so that the problem that the reflectivity and transmittance of the polarization beam splitter 2 for non-polarized light are low can be avoided, which is beneficial to reducing the loss of light in the optical scanning system 100, improving the utilization rate of light, and improving the scanning performance of the optical scanning system 100.

As shown in FIG. 1 and FIG. 2, the polarization converter 1 includes a plurality of sub-polarization prisms 10, a plurality of half-wave plates 11, and a polarization dielectric film 13. The sub-polarization prisms 10 are bonded by, but not limited to, glass glue or hydrosol. Each polarization dielectric film 13 is at the connection position of two adjacent sub-polarization prisms 10. Each half-wave plate 11 is arranged at intervals on the light-emitting side surface of the polarization converter 1. The half-wave plates 11 are spaced apart from each other and bonded to the light-emitting surface of the polarization converter 1 by, but not limited to, glass glue or water gel.

When the polarization converter 1 receives the first light L1 and the second light L2, the polarization dielectric films 13 transmit the first light L1 and reflect the second light L2. The second light L2 reflected from the polarization dielectric films 13 is emitted from the sub-polarization prism 10. The first light L1 transmitted from the polarization dielectric films 13 is incident on the half-wave plate 11, and the half-wave plate 11 is configured to receive the first light L1 transmitted from the polarization dielectric films 13 and convert the polarization state of the first light L1 into the second polarization state before emitting.

In one embodiment, the first light L1 is horizontal linear polarized light, the second light L2 is vertical linear polarized light. That is, the first polarization state is a horizontal polarization state, and the second polarization state is a vertical polarization state. When horizontal linear polarized light and vertical linear polarized light are incident on the polarization converter 1, the vertical linear polarized light is reflected by the polarization dielectric films 13 and directly emitted from the sub-polarizing prisms 10. The horizontal linear polarized light is transmitted from the polarization dielectric films 13 to the half-wave plates 11, and the half-wave plates 11 convert the horizontal linear polarized light into the vertical linear polarized light and then emit the vertical linear polarized light. That is, the polarization state of the first light L1 is converted into the second polarization state. The second light L2, together with the first light L1 whose polarization state has been converted, are emitted as the third light L3 with a vertical polarization state.

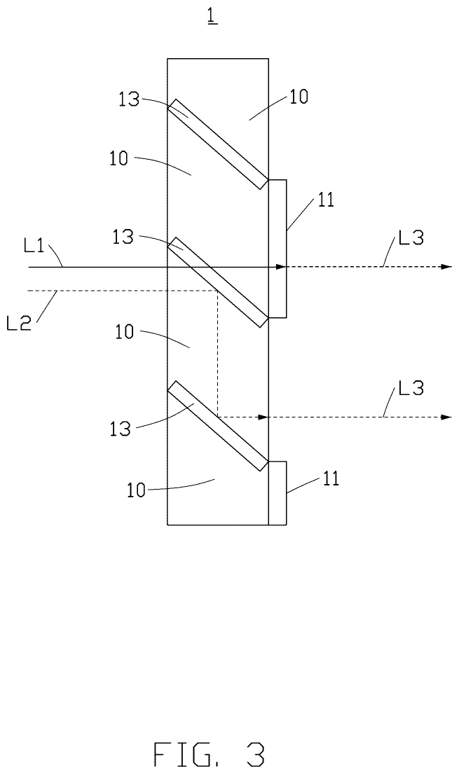

As shown in FIG. 3, in another embodiment, the first light L1 is a vertical linear polarized light, the second light L2 is a horizontal linear polarized light. That is, the first polarization state is a vertical polarization state, and the second polarization state is a horizontal polarization state. When the horizontal linear polarized light and the vertical linear polarized light are incident on the polarization converter 1, the horizontal linear polarized light is reflected by the polarization dielectric films 13 and directly emitted from the sub-polarizing prisms 10. The vertical linear polarized light is transmitted from the polarization dielectric films 13 to the half-wave plates 11, and the half-wave plates 11 convert the vertical linear polarized light into the horizontal linear polarized light and then emits the horizontal linear polarized light. That is, the polarization state of the first light L1 is converted into the second polarization state. The second light L2, together with the first light L1 whose polarization state has been converted, are emitted as the third light L3 with a horizontal polarization state.

The polarization beam splitter 2 includes two right-angle prisms 20, and a polarization beam splitter dielectric film 21. The inclined surfaces of two right-angle prisms 20 are glued, and the polarization beam splitter dielectric film 21 is plated on the inclined surfaces at the joint of the right-angle prisms 20. When the light is incident at the Brewster angle, the transmittance of the polarization beam splitter 2 to the horizontal linear polarized light is about 1, and the transmittance to the vertical linear polarized light is less than 1, but the reflectivity to the vertical linear polarized light is about 1.

In one embodiment, the first polarization state is a horizontal polarization state, and the second polarization state is a vertical polarization state. When the third light L3 with the second polarization state is incident on the polarization beam splitter 2, the third light L3 is reflected from the polarization beam splitter dielectric film 21 to the phase delay element 3. When the scanning light LS having the first polarization state is incident on the polarization beam splitter 2 at the Brewster angle, the scanning light LS is transmitted from the polarization beam splitter medium film 21 out of the polarization beam splitter 2. In other embodiments, the polarization beam splitter 2 may further have a transmittance of about 1 for vertically polarized light, a transmittance of about 0 for horizontally polarized light, and a reflectivity of about 1.

The phase delay element 3 may be formed by directional stretching of a thin film or processing of a birefringent material, and the phase delay element 3 is attached to the surface of the reflecting light output side of the polarization beam splitter 2. The phase delay element 3 is configured to adjust the polarization state of the third light L3. The phase delay element 3 is a quarter wave plate or a half wave plate. The phase delay element 3 is configured to receive the third light L3 emitted from the polarization beam splitter 2 or the fifth light L5 emitted from the scanning element 4. The phase delay element 3 can convert the third light L3 into the fourth light L4 and convert the fifth light L5 into the scanning light LS.

In one embodiment, the first polarization state is a horizontal polarization state, and the second polarization state is a vertical polarization state, the phase delay element 3 converts the vertical linear polarization light into a left-handed circular polarization light. That is, the third light L3 is converted into the fourth light L4, and the third polarization state is a circular polarization state. The phase delay element 3 converts the right-handed circular polarization light into a horizontal linear polarization light. That is, the fifth light L5 is converted into the scanning light LS, and the fourth polarization state is a circular polarization state.

In other embodiments, the first polarization state is a vertical polarization state, and the second polarization state is a horizontal polarization state, and the phase delay element 3 converts the horizontal linear polarization light into a right-handed circular polarization light. That is, the third light L3 is converted into the fourth light L4, and the third polarization state is a circular polarization state. The phase delay element 3 converts the left-handed circular polarization light into a vertical linear polarization light. That is, the fifth light L5 is converted into the scanning light LS, and the fourth polarization state is a circular polarization state.

The scanning element 4 can be, but not limited to, a micro-vibration mirror, an optical phased array chip, or a digital micromirror device. When the scanning element 4 is a micro-vibration mirror, the micro-vibration mirror can be controlled by a rocker arm (not shown) to deflect to achieve multi-angle scanning of the fifth light L5. When the scanning element 4 is an optical phased array chip, the optical phased array chip has multiple grating structures (not shown) to control deflection to achieve multi-angle scanning of the fifth light L5. When the scanning element 4 is a digital micromirror device, a motor (not shown) is provided under the digital micromirror device to control deflection to achieve multi-angle scanning of the fifth light L5. The scanning element is configured to receive the fourth light L4 and emit the fifth light L5 having the fourth polarization state toward the phase delay element 3.

As shown in FIG. 1, the optical scanning system 100 further includes a collimator 5 and a focusing lens 6. The collimator 5 is arranged on the light-emitting side of a light source and is configured to receive and collimate the first light L1 and the second light L2 emitted from the light source. The focusing lens 6 is arranged on the light-emitting side of the polarization converter 1 and is configured to receive the third light L3 emitted from the polarization converter 1 and focus the third light L3 on the polarization beam splitter 2.

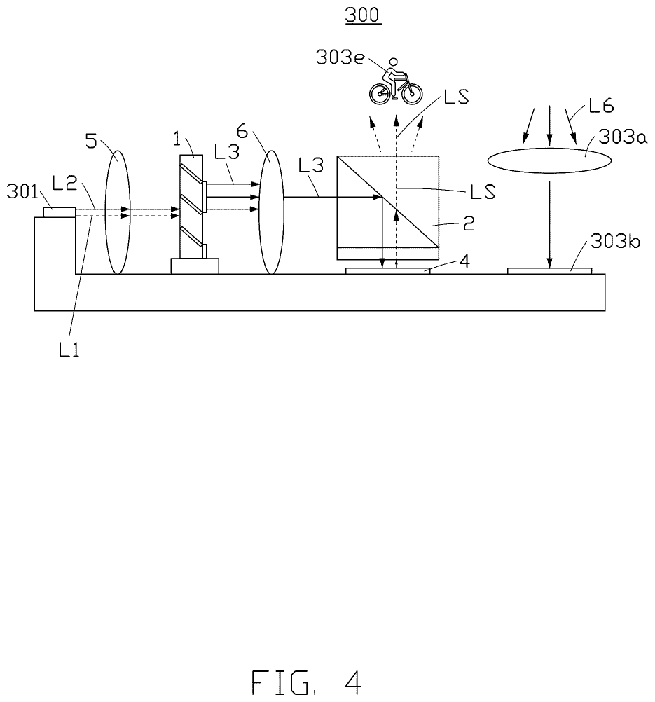

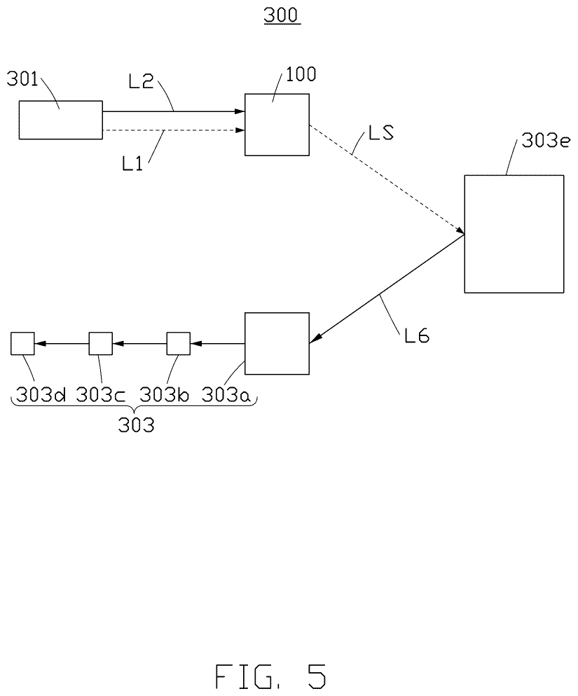

As shown in FIG. 4 and FIG. 5, a laser radar 300 includes a laser emitting system 301, the optical scanning system 100, and a laser receiving system 303. The laser emitting system 301 is configured to emit the first light L1 having the first polarization state and the second light L2 having the second polarization state. The laser emitting system 301 can be, but not limited to, a liquid laser emitting system, a gas laser emitting system, and a solid laser emitting system (such as, optical fiber, semiconductor, all-solid-state, hybrid). The optical scanning system 100 is configured to receive the first light L1 and the second light L2 and convert the first light L1 and the second light L2 into the scanning light LS to emit to a target 303e to be measured. The laser receiving system 303 is configured to receive a return light L6 reflected from the target 303e to be measured and obtain the information of the target 303e to be measured based on the return light L6.

The laser receiving system 303 includes a light receiving lens 303a and a light sensor 303b. The light receiving lens 303a is configured to focus the return light L6 to improve the light receiving rate of the laser radar 300. The light receiving lens 303a can be made of, but not limited to, glass or resin. The light sensor 303b is configured to receive the return light L6 emitted from the light receiving lens 303a and convert the return light L6 into an electrical signal.

The laser receiving system 303 further includes a transimpedance amplifier 303c and an analog-to-digital converter 303d. The electrical signal passes through the transimpedance amplifier 303c, and the transimpedance amplifier 303c is configured to receive the electrical signal transmitted by the light sensor 303b and amplify the electrical signal. The electrical signal finally passes through the analog-to-digital converter 303d, and the analog-to-digital converter 303d is configured to convert the continuous analog signal into a discrete digital signal, thereby facilitating signal processing and data conversion, and facilitating computer control and calculation.

The laser radar 300 adopts the optical scanning system 100 which is conducive to reducing the loss of light in the laser radar 300 and improving the utilization rate of light. The laser radar 300 can effectively emit the scanning light LS to the target 303e to be measured, which is conducive to improving the overall detection performance of the laser radar 300.

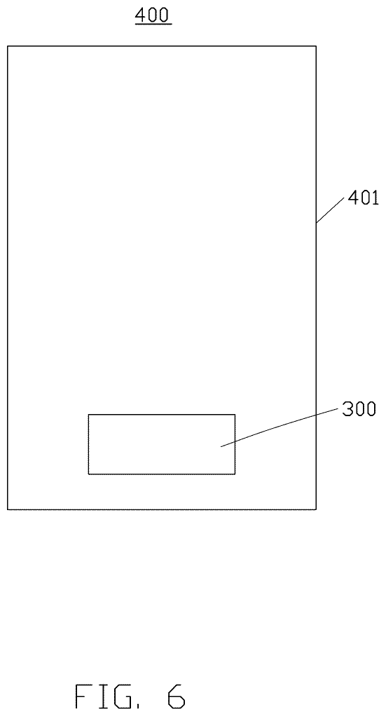

As shown in FIG. 6, a vehicle 400 includes a body 401 and the laser radar 300 on the body 401. The vehicle can be, but not limited to, an electric vehicle, a gasoline vehicle, a diesel vehicle and a hybrid vehicle. The body 401 can further include a positioning system (not shown) and a control system (not shown). The positioning system is configured to obtain information about the vehicle 400 by connecting to a satellite navigation system. The control system is configured to adjust the speed and steering angle of the vehicle 400 in real time according to the information between the laser radar 300 and the target 303e to be measured.

The vehicle 400 by adopting the laser radar 300 is beneficial to increasing the safety during driving, thus extending the service life of the vehicle 400.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. An optical scanning system comprising a polarization converter, a polarization beam splitter, a phase delay element, and a scanning element;
wherein the polarization converter is configured to receive a first light having a first polarization state and a second light having a second polarization state and to emit a third light having the second polarization state;
the polarization beam splitter is configured to receive and reflect the third light to the phase delay element;
the phase delay element is configured to receive the third light and emit a fourth light having a third polarization state to the scanning element;
the scanning element is configured to receive the fourth light and emit a fifth light having a fourth polarization state in a variable direction to the phase delay element;
the first polarization state, the second polarization state, the third polarization state and the fourth polarization state are different from each other;
the phase delay element is further configured to convert the fifth light into a scanning light having the first polarization state; and
the polarization beam splitter is further configured to transmit the scanning light.

2. The optical scanning system according to claim 1, wherein the polarization converter comprises a half-wave plate and a polarization dielectric film, the polarization dielectric film is configured to reflect the second light and transmit the first light, and the half-wave plate is configured to receive the first light from the polarization dielectric film and convert the polarization state of the first light into the second polarization state.

3. The optical scanning system according to claim 1 further comprising a collimator configured to collimate the first light and the second light to the polarization converter.

4. The optical scanning system according to claim 1 further comprising a focusing mirror between the polarization converter and the polarization beam splitter, wherein the focusing mirror is configured to receive the third light emitted from the polarization converter and focus the third light to the polarization beam splitter.

5. The optical scanning system according to claim 1, wherein the scanning element is a micro-vibration mirror, an optical phased array chip or a digital micromirror device.

6. The optical scanning system according to claim 1, wherein the first polarization state is a horizontal polarization state, the second polarization state is a vertical polarization state, the third polarization state is a left-handed circular polarization state, and the fourth polarization state is a right-handed circular polarization state.

7. The optical scanning system according to claim 1, wherein the first polarization state is a vertical polarization state, the second polarization state is a horizontal polarization state, the third polarization state is a right-handed circular polarization state, and the fourth polarization state is a left-handed circular polarization state.

8. A laser radar comprising:
a laser emitting system configured to emit a first light having a first polarization state and a second light having a second polarization state;
an optical scanning system comprising a polarization converter, a polarization beam splitter, a phase delay element, and a scanning element, wherein the polarization converter is configured to receive the first light and the second light and to emit a third light having the second polarization state;
the polarization beam splitter is configured to receive and reflect the third light to the phase delay element; the phase delay element is configured to receive the third light and emit a fourth light having a third polarization state to the scanning element; the scanning element is configured to receive the fourth light and emit a fifth light having a fourth polarization state in a variable direction to the phase delay element; the first polarization state, the second polarization state, the third polarization state and the fourth polarization state are different from each other; the phase delay element is further configured to convert the fifth light into a scanning light having the first polarization state, and the polarization beam splitter is further configured to transmit the scanning light to a target to be measured; and
a laser receiving system configured to receive a return light reflected from the target to be measured and obtain information of the target based on the return light.

9. The laser radar according to claim 8, wherein the polarization converter comprises a half-wave plate and a polarization dielectric film, the polarization dielectric film is configured to reflect the second light and transmit the first light, and the half-wave plate is configured to receive the first light from the polarization dielectric film and convert the polarization state of the first light into the second polarization state.

10. The laser radar according to claim 8, wherein the optical scanning system further comprises a collimator configured to collimate the first light and the second light to the polarization converter.

11. The laser radar according to claim 8, wherein the optical scanning system further comprises a focusing mirror between the polarization converter and the polarization beam splitter, wherein the focusing mirror is configured to receive the third light emitted from the polarization converter and focus the third light to the polarization beam splitter.

12. The laser radar according to claim 8, wherein the scanning element is a micro-vibration mirror, an optical phased array chip or a digital micromirror device.

13. The laser radar according to claim 8, wherein the first polarization state is a horizontal polarization state, the second polarization state is a vertical polarization state, the third polarization state is a left-handed circular polarization state, and the fourth polarization state is a right-handed circular polarization state.

14. The laser radar according to claim 8, wherein the first polarization state is a vertical polarization state, the second polarization state is a horizontal polarization state, the third polarization state is a right-handed circular polarization state, and the fourth polarization state is a left-handed circular polarization state.

15. A vehicle comprising a body, and a laser radar on the body, the laser radar comprising:
a laser emitting system configured to emit a first light having a first polarization state and a second light having a second polarization state;
an optical scanning system comprising a polarization converter, a polarization beam splitter, a phase delay element, and a scanning element, wherein the polarization converter is configured to receive the first light and the second light and to emit a third light having the second polarization state;
the polarization beam splitter is configured to receive and reflect the third light to the phase delay element; the phase delay element is configured to receive the third light and emit a fourth light having a third polarization state to the scanning element; the scanning element is configured to receive the fourth light and emit a fifth light having a fourth polarization state in a variable direction to the phase delay element; the first polarization state, the second polarization state, the third polarization state and the fourth polarization state are different from each other; the phase delay element is further configured to convert the fifth light into a scanning light having the first polarization state, and the polarization beam splitter is further configured to transmit the scanning light to a target to be measured; and
a laser receiving system configured to receive a return light reflected from the target to be measured and obtain information of the target based on the return light.

16. The vehicle according to claim 15, wherein the polarization converter comprises a half-wave plate and a polarization dielectric film, the polarization dielectric film is configured to reflect the second light and transmit the first light, and the half-wave plate is configured to receive the first light from the polarization dielectric film and convert the polarization state of the first light into the second polarization state.

17. The vehicle according to claim 15, wherein the optical scanning system further comprises a collimator configured to collimate the first light and the second light to the polarization converter.

18. The vehicle according to claim 15, wherein the optical scanning system further comprises a focusing mirror between the polarization converter and the polarization beam splitter, wherein the focusing mirror is configured to receive the third light emitted from the polarization converter and focus the third light to the polarization beam splitter.

19. The vehicle according to claim 15, wherein the scanning element is a micro-vibration mirror, an optical phased array chip or a digital micro-mirror device.

20. The vehicle according to claim 15, wherein the first polarization state is a horizontal polarization state, the second polarization state is a vertical polarization state, the third polarization state is a left-handed circular polarization state, and the fourth polarization state is a right-handed circular polarization state; or, the first polarization state is a vertical polarization state, the second polarization state is a horizontal polarization state, the third polarization state is a right-handed circular polarization state, and the fourth polarization state is a left-handed circular polarization state.
